(19) United States
(12) Patent Application Publication
(10) Pub. No.: US 2010/0243095 A1
(43) Pub. Date: Sep. 30, 2010

(54) Thermally insulating protection element for piping

(76) Inventor: Remi Bourlart, Bellignies (FR)

Correspondence Address: JACOBSON HOLMAN PLLC, 400 SEVENTH STREET N.W., SUITE 600, WASHINGTON, DC, 20004, US

(21) Appl. No.: 12/659,583

(22) Filed: Mar. 12, 2010

(30) Foreign Application Priority Data
Mar. 17, 2009 (FR) 0 951 675

(51) Int. Cl. F16L 55/00

(52) U.S. Cl. 138/104; 138/157

(57) ABSTRACT

This invention relates to a thermally insulating protection element (1) for piping, comprising a hollow body (10) with an open concavity (10A) and having a wall (11), characterized in that its wall (11) comprises at least one rigid positioning and/or support platform (16) designed to accommodate the fastening of technical equipment to be associated with the said protection element. The element is designed to not only insulate piping, but also to constitute a direct means for supporting and fastening technical equipment such as a sensing line.

The invention relates to a protection element for the thermal insulation of piping, the element being also designed to act as a supporting device for technical equipment that has to be routed along the piping. In particular, the technical equipment ideally follows the piping in order to detect any leaks from the piping.

The invention has been described more particularly in the context of the use of such protection elements in the field of aeronautics, for piping particularly carrying air at a high temperature and/or under high pressure. However, the invention applies to all areas involving protection elements or shells for piping.

In aircraft, dozens of metres of piping are arranged to collect air at high temperatures (260 to 540° C.) or under pressure (5 to 15 bar) from certain areas, such as at the engines, and to distribute that air to treatment systems that particularly make it possible to supply conditioned and/or pressurised air to specific spaces such as the cabin, in the passenger area, or provide hot air to the wings of the aircraft in order to defrost their leading edges.

The piping passes through unpressurised areas of the aircraft that are subjected to transport conditions, and is therefore exposed to the temperature and pressure conditions of the surrounding environment, particularly with temperatures of up to −50° C. and pressures as low as 0.2 bar. That is why it is necessary to insulate the piping thermally in order to carry the pressurised air at high temperatures without excessive thermal losses.

Further, it is imperative and even required by standards for the piping to have thermal insulation that is such that the surface temperature of the piping does not exceed 204° C. in order to avoid the risk of auto-ignition of fluids that may inopportunely come into contact with the outside of the pipes, as these pipes go through areas carrying fluids such as aircraft fuel.

The piping is made of metal and is thermally insulated in a known manner by wrapping made of thermally insulating material such as foam or mineral wool, and rigid protection elements placed above the insulating material. The protection elements or at least their external skin are generally made of metal or composite materials or silicone or even titanium.

The protection elements are formed of two half shells in which the pipe is sandwiched and surrounded by insulating material. The half shells are made integral with the pipe by welding at their free ends, which have metal connecting sections with a Z-shaped cross-section one side of which is connected to the external skin of a half shell by gluing or welding, while the other side is designed to be welded to the pipe.

The piping is formed of sections joined end to end and welded to each other, and some of these are connected to closing and opening and/or regulation systems such as valves or angular compensators. There is a risk of leaks from the pipes and their connections, for instance relating to the propagation of cracks in the piping, incorrect welding between sections or the loss of tightness at a valve system.

Leak detection is however a necessity, because these pipes run, as has been said earlier, in zones containing fluids that can self ignite in contact with air at a high temperature.

Also, leaks can lead to a loss of function by the end system to be supplied (defrosting, air conditioning etc.)

In order to detect any leaks from the piping, the half shells of thermal insulation have orifices or aeration holes from which hot air can escape in the event of a leak, while a detection device such as sensing line is placed along the piping, with sensors opposite the aeration holes that are capable of detecting any hot air that may escape.

A sensing line is installed with supports similar to rings that are added around the thermal insulation of the pipes, which hold a cable at a certain distance from the pipe, carrying regularly spaced sensors that are located opposite the aeration holes.

These detection devices can only be put in place after the piping has been installed. Because of the intertwining of pipes in a small space, the work of putting in place and fastening a number of rings is not practical and remains fastidious, the more so since it is subsequently necessary to correctly position the cable with the sensors and the sensors opposite the aeration holes. Besides, an incorrectly fastened ring can lead to cable movement and thus a shift in the position of one or more sensors, which destroys the chance of efficient or even effective detection.

The invention is thus aimed at providing a thermally insulating protection element for piping in order to form a thermal insulation shell, which protection element carries out the additional function of supporting technical equipment and allowing fast and easy installation of the equipment, while guaranteeing appropriate positioning; that placing further remains reliable over time.

According to the invention, the thermally insulating protection element for piping comprises a hollow body with open concavity such as a half shell, and having a wall, and is characterized in that its wall comprises at least one rigid positioning and/or support platform that is designed to accommodate the fastening of technical equipment that is to be associated with the said protection element.

That platform is thus integrated into the thickness of the wall. It does not constitute an independent element, but forms integral part of the body by being a constitutive and inseparable member of the said body. It forms a substantially flat surface. It constitutes means for positioning and/or supporting a device external to the protection element and distinct from the other protection element that may be added in a manner opposed to the said element and opposite the cavity in a way as to form a full shell.

The platform thus provides a support for subsequent fastening.

Also, it imposes the location of the technical equipment to be associated with the protective material around the pipe. There is no need for first calculating and positioning the place where the locating and/or fastening of the technical equipment is to be planned.

The platform is also used to make the half shell more rigid, thus avoiding deformation of the half shell over time.

Lastly, the platform is raised above the remainder of the body and therefore above the pipe, placing the technical equipment to be associated at a certain separating distance from the pipe. In particular, for application in aeronautics with sensing lines, the lines are automatically set at the required distance from the shell and are set with certain regularity.

That raising or boss in relation to the external side of the body facing the external environment is provided on the general side of the wall in order to make it more easily accessible as a means for positioning and attachment. That platform is not a means for connecting or assembling two hollow bodies to each other to form a shell, but has the function of allowing the appropriate positioning and fastening of an added outside element.

According to one characteristic, the platform comprises at least one hole constituting a fastening means. It is designed to house a screw or rivet, for example, for fastening the technical element.

The platform is designed to be sufficiently rigid. In that way, the wall can be reinforced by the very nature of the material or materials that make up the said platform. As an alternative or in combination, the platform may have a shape where the lines are designed to reinforce the structure. It may be envisaged that the platform has at least one insert of the metallic type embedded in the wall of the body of the element.

According to another characteristic, the wall of the body is made up of insulating material(s) that are capable of being moulded, such as materials made of plastic of the epoxy resin type and/or thermally insulating fibres such as fibreglass.

In addition to its property of thermal insulation, the composite material of the protective element of the invention offers the advantage of reducing the mass of the structure in relation to a metal enclosure, which is not without value in aircraft, where the reduction of weight is a constant concern, particularly in order to save fuel and protect the environment.

Advantageously, the wall of the body of the protection element has at least one escape hole that may be covered by a protective pad that is removable or not, and the escape hole is preferentially placed near the platform.

The removable pad makes it possible to use protection elements with or without a hole. If one or more escape holes are useful, particularly in the application of the invention in aeronautics for detecting any leak of fluid from the pipe, it is sufficient to pierce or detach the protective pad before adding the protection element against the pipe.

The protection element is indeed designed to cover a pipe with its open concavity.

It is thus designed to be used along with an opposite complementary cover to form an insulating protective shell that encloses the said pipe.

The protection element of the invention is used for fastening technical elements designed to follow the path of the piping against which the said element is added.

In particular, by means of the platform or platforms, it supports a sensing line with at least one sensor placed opposite an escape hole so as to detect any leak from the piping. The arrangement of the hole near the platform advantageously makes it possible to position a sensor at the appropriate location, namely opposite a hole, the sensing line bearing the sensors being already advantageously well positioned by being fastened to the platforms.

Lastly, the protection element is added against the piping arranged more particularly in a building or in a locomotion vehicle of the air, rail, water or road type.

This invention is now described with examples that are merely illustrative and do not in any way limit the scope of the invention, and by reference to the attached drawings, wherein:

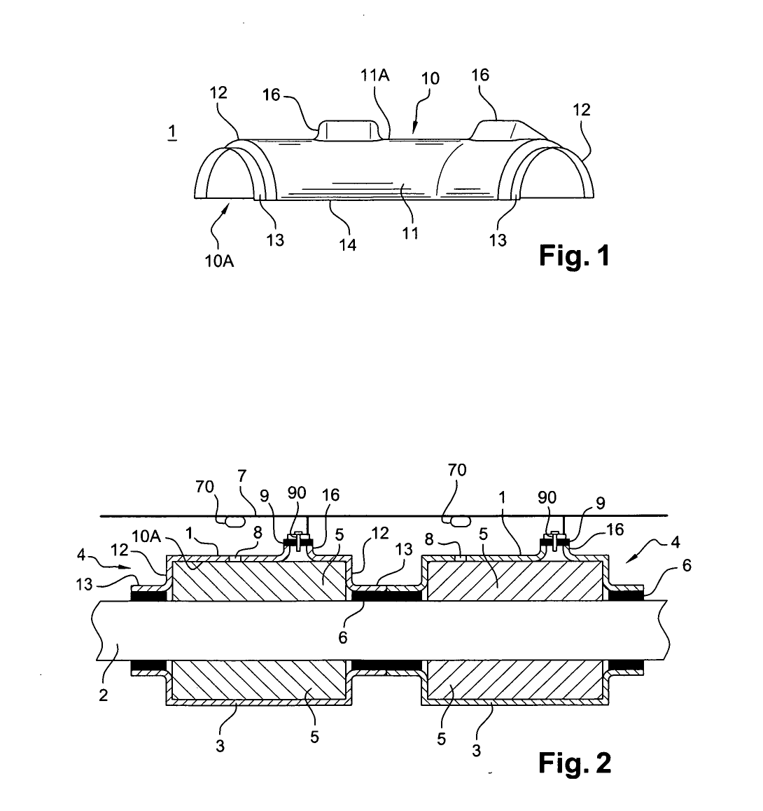

FIG. 1 represents a perspective view of a protection element according to the invention;

FIG. 2 is a view of a longitudinal section of a pipe associated with protection elements according to the invention and complementary elements to form protective shells for the pipe;

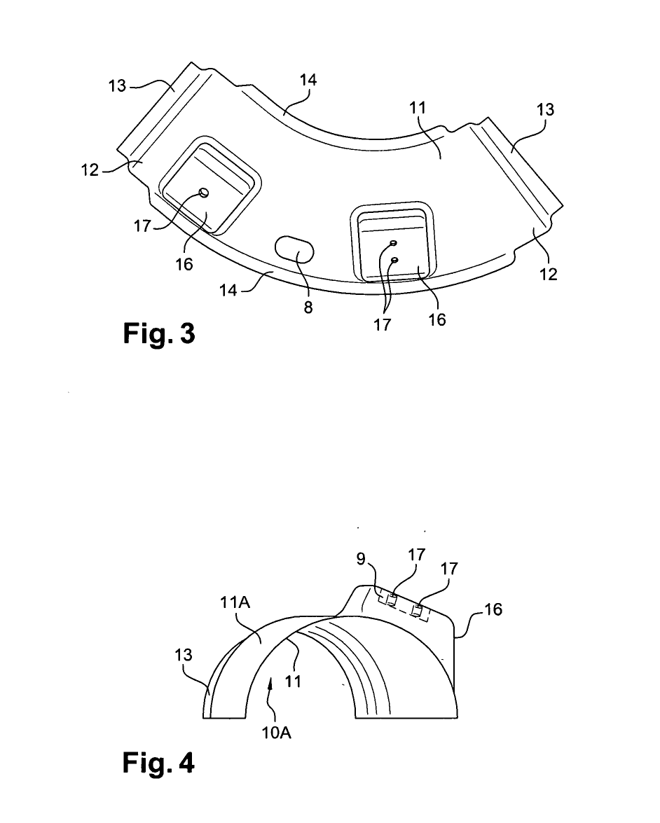

FIG. 3 represents a perspective and top view of the protection element of FIG. 1.

FIG. 4 represents a perspective and sectional view of a platform of the protection element according to the invention.

FIG. 1 illustrates a protection element 1 according to the invention for the thermal insulation of pipes.

This protection element, with an open concavity 10A, forms a half shell. Its constitutive material is material that is capable of being moulded. It is preferably a composite material made from plastic of the epoxy resin type and/or fibres with thermal insulation properties such as fibreglass.

Such a half shell is designed to cover pipes by being assembled opposite a half shell with similar mechanical and insulating properties and generally an equivalent shape, to form a protective shell.

FIG. 2 represents a sectional view of a pipe 2 sandwiched between one half shell 1 of the invention and the complementary half shell 3, together making up a protective shell 4 around the pipe. Such a shell is for instance used for the thermal protection of the pipes used in aircraft, which convey air at a high temperature (up to 540° C.). The pipes are wrapped in thermal insulation 5 such as foam or insulating wool and covered by the protection shell 4 that forms an external skin, the temperature of which does not exceed 204° C. in accordance with the standards applicable in the area of aeronautics.

The protection element or half shell 1 may be straight or bent to adapt to the shape of the pipe to cover.

As illustrated in FIGS. 1 and 3, the protection element 1 has a body 10 comprising a wall 11 with a shape that is substantially concave or semi-cylindrical to cooperate with the substantially cylindrical shape of the pipes, and free ends 12.

Advantageously, the wall 11 has a shoulder 13 at each end 12 of the body that is designed for making the protection element integral with the pipe.

The wall 11 has free lateral edges 14 designed to constitute support edges for the opposite edges of the complementary half shell 3 to assemble.

Optionally, and in relation with the purpose of the half shell, the half shell has holes 8 to allow, as will be described later, the fluid flowing in the pipes to escape if the pipes have a leak.

As can be seen in FIG. 2, the protection element 1 is assembled on the pipe by placing the concavity 10A of the body against the insulation 5, and by setting the ends 12 against the pipe 2. Fastening is carried out by gluing means 6 adapted to the connection of the metal material of the pipe to the composite materials of the ends 12, more particularly of the shoulder 13.

Note that the fastening of the ends 12 of the protection element is carried out advantageously directly at the body 10 by the adapted conformation of the shoulders 13. However, the body 10 may, as in the earlier art, have ends 12 with no shoulders; a Z-shaped metal section would then be added by gluing against the inside of the wall 11 at each end 12, and the protection element would be fastened by welding the metal sections against the pipe.

The complementary half shell 3 is added and fastened to the pipe in the is same way as the protection element 1. It is assembled with the protection element 1 by welding its lateral edges to the supporting edges 14 of the said protection element.

As can be seen in FIG. 2, the pipe 2 comprises several shells 4 joined end to end with each other to follow the linearity or curves of the pipe. Each protection element 1 of a protection shell is associated with the same side of the pipe.

According to the invention, the protection element 1 acts as the means for supporting and positioning technical equipment 7 to be associated with the pipe (FIG. 2).

The technical equipment 7 may for example be a sensing line for detecting leaks of air or other gases from the pipe. The line may itself be a sensor or be replaced by a series of sensors 70 distributed discretely, and must imperatively follow the pipe, at a specific distance from the pipe and in such a way that the sensors are placed in the immediate vicinity of at least one escape hole 8 provided in the protection element. In the event of a leak, the air escapes from the holes 8 and is detected by the sensors.

According to the invention, the protection element has a configuration that makes it directly support the sensing line. The wall 11 of the protection element 1 comprises at least one projecting shape or rigid platform 16 that constitutes a means for positioning and/or supporting the technical equipment 7 to be associated with the said element.

The platform constitutes a boss in relation to the external side 11A of the wall, which is the side opposite the open concavity 10A. It is formed by moulding when the body of the element is manufactured.

The platform 16 is sufficiently rigid or may integrate in the wall of the body, as can be seen in FIGS. 2 and 4, at least one metal insert 9, to provide a support and fastening zone. The insert is made integral by insertion in the composite material of the body 10 during the manufacturing by moulding of the protection element.

The platform 16 advantageously has at least one hole 17 that can be seen in FIGS. 3 and 4, which is designed to cooperate with a fastening piece 90 (FIG. 2) such as a screw or a rivet for fastening the technical element 7. Depending on the type of fastening used for the equipment to associate, the hole may be smooth or threaded.

The sensing line is thereby fastened for example in the manner shown in FIG. 2, the said sensing line being a cable associated at a distance from the remainder of the body 10 of the protection element, and thus at a distance from the pipe. The line may be replaced by a series of sensors 70 distributed discretely. The sensors are then positioned appropriately, directly opposite the escape holes 8.

The protection element in the invention is therefore used to provide, in addition to its thermal insulation function, the function of supporting for positioning and/or fastening equipment, thanks to the presence of a rigidified platform forming a surface that is appropriate for fastening.

1. A thermally insulating protection element (1) for piping, comprising a hollow body (10) with an open concavity (10A) and having a wall (11), characterized in that its wall (11) comprises at least one rigid platform (16) constituting a boss in relation to the external side (11A) of the wall and constituting a positioning and/or support means designed to accommodate the fastening of technical equipment to be associated with the said protection element.

2. A protection element according to claim 1, characterized in that the platform (16) comprises at least one hole (17) constituting a fastening means.

3. A protection element according to claim 1, characterized in that the platform (16) comprises at least one insert (9) embedded in the wall (11) of the body of the element.

4. A protection element according claim 1, characterized in that the wall (10) of the body is made of thermally insulating material(s) capable of being moulded, such as materials made of plastic of the epoxy resin type, and/or thermally insulating fibres such as fibreglass.

5. A protection element according to claim 1, characterized in that the wall (10) of the body has at least one escape hole (8) that can be covered by a protection pad that is removable or not, the escape hole being preferentially placed near the platform (16).

6. A protection element according to claim 1, characterized in that it is designed to cover a pipe (2) with its open concavity (10A).

7. A protection element according to claim 6, characterized in that it is designed to be associated with a complementary cover (3) located opposite it to form an insulating protection shell (4) enclosing the said pipe (2).

8. A protection element according to claim 1, characterized in that it is used to fasten technical elements (7) designed to follow the path of the piping against which the said element is added.

9. A protection element according to claim 5, characterized in that it supports, by means of the platform or platforms (16), a sensing line (7) with at least one sensor (70) arranged opposite an escape hole (8).

10. A protection element according to claim 1, characterized in that it is added against piping arranged in a building or in a locomotion vehicle of the air, rail, water or road type.
